(19) United States
(12) Patent Application Publication
(10) Pub. No.: US 2007/0150651 A1
(43) Pub. Date: Jun. 28, 2007

(54) Method for dynamically exposing backup and restore volumes

(75) Inventors: Daniel Nemiroff, Folsom, CA (US); Fran Corrado, Newton, MA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/317,505

(22) Filed: Dec. 22, 2005

(51) Int. Cl. G06F 12/16

(52) U.S. Cl. 711/114

(57) ABSTRACT

A method and apparatus for storing and protecting a restore environment is provided. The restore environment is stored in a redundant array of independent disks (RAID) volume which is hidden from an operating system during runtime operations. Upon detecting that a restore operation is required due to a corrupted or missing image, the RAID volume storing the restore environment is dynamically exposed so that it can be accessed by the restore operation.

### FIELD OF THE INVENTION

This disclosure relates to backup and restore and in particular to restoring a backup image of an operating system.

### BACKGROUND

Typically, during the installation of an operating system, a removable emergency repair disk is created that stores a restore environment that allows the system to be recreated in the event of total failure. The removable emergency repair disk is typically a Compact Disc (CD) or Digital Video Disc (DVD). The restore environment allows the operating system to be restored in an environment outside of the operating system. During the restore operation, the restore environment is loaded from the emergency repair disk and the operating system is restored by reloading the operating system from a backup image stored on the emergency repair disk. The problem with this restore method is that if the emergency repair disk is lost there is no method to recover the restore environment.

To avoid the problem of losing the removable emergency repair disk, the restore environment may be stored on a non-removable disk in the computer system. Typically, the restore environment is stored on a separate partition of the non-removable drive that is, a logically distinct portion that functions as though it was a physically separate unit. However, during runtime the separate partition is visible to the operating system and can thus be deleted or corrupted for example, by malicious software such as a computer virus.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an embodiment of a computer system that restores a backup image according to the principles of the present invention;

FIG. 2 is a flow chart illustrating a method implemented by the volume manager for creating a RAID volume;

FIG. 3 illustrates a logical view of the set of physical disk drives during run-time;

FIG. 4 is a flowchart of a method for creating a backup image according to an embodiment of the invention;

FIG. 5 is a logical view of an embodiment of the invention while a backup image is being taken of the user volume;

FIG. 6 is a flowchart of an embodiment of a method for restoring a user volume implemented in the Microsoft Windows operating system; and

FIG. 7 is a logical view of an embodiment of the invention during restore.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

A Redundant Array of Inexpensive Disks (RAID) array is formed from a set of physical disk drives and data is distributed across the set of disk drives that function as a single storage unit. Typically, the data is distributed across RAID array using a method defined by one of a plurality of RAID levels to ensure data will not be lost if one of the disk drives fails. The single storage unit may be logically divided into several RAID volumes. Each RAID volume may be distributed across the set of disk drives and is treated as a separate logical disk drive.

In an embodiment of the invention, one of the RAID volumes is used to store and protect a restore environment. The RAID volume used to store the restore environment may be hidden, that is, the volume is not visible to the operating system or application programs running in the computer system. By hiding the restore environment volume, the restore environment volume is not shown in the normal listing of the volumes to the operating system or in a user interface in order to protect the volume from deletion or modification.

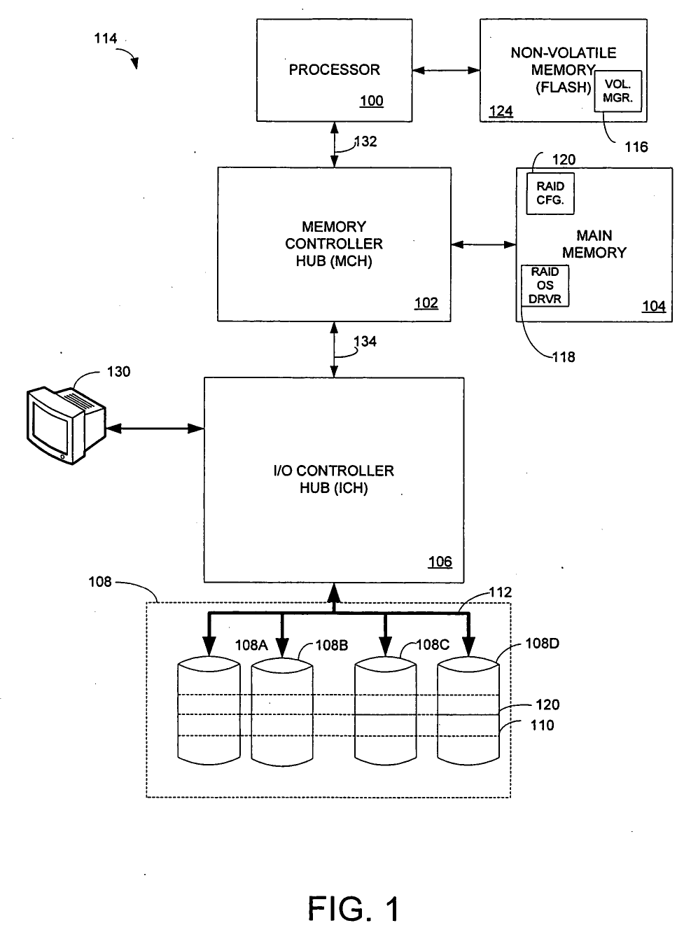

FIG. 1 is a block diagram of an embodiment of a computer system 114 that restores a backup image according to the principles of the present invention. The computer system 114 includes an Input/Output (I/O) Controller Hub (ICH) 106, a processor 100 and a Memory Controller Hub (MCH) 102. The MCH 102 manages a memory 104 that is coupled to the MCH. In one embodiment, the memory 104 is a 64-bit wide double data rate (DDR2) memory. The processor 100 is coupled to the MCH 102 by a host interface 132. The MCH 102 is coupled to the ICH 106 by a high-speed direct media interface 134. The ICH 106 manages I/O devices including storage devices coupled to a storage interface.

In one embodiment, the storage controller manages Serial Advanced Technology Attachment (SATA) devices coupled to a SATA bus 112. The SATA protocol is a standard serial storage protocol available at www.sata-io.org. In an embodiment, the I/O controller hub (ICH) 106 includes a Serial Advanced Technology Attachment (SATA) interface that includes four ports each of which may be coupled to a SATA device 108A-B such as, a disk drive or other storage device.

In other embodiments, the ICH 106 may manage storage devices using other storage protocols, for example, Internet Small Computer Systems Interface (iSCSI), Fibre Channel, and Serial Attached Storage (SAS).

The computer system includes software components to provide a Redundant Array of Independent Disks (RAID) capability. The software components include firmware in a RAID Option ROM stored in a non-volatile memory 124 such as Flash memory coupled to the processor 100, an operating system RAID driver 118, and a user interface for configuration and management of the RAID capability 120. The firmware in the Option ROM will be referred to as a RAID “volume manager” 116. The RAID volume manager 116 includes firmware for pre-boot configuration and boot functionality. The firmware in the RAID Option ROM is linked into the core Basic Input Output Operating System (BIOS) image.

RAID capability allows an array of physical disk drives 108A-D to be aggregated into a single logical storage unit 108. RAID software components that execute in the computer system 114 distribute data across the set of disk drives 108A-D based on one of a plurality of RAID levels. As is well known to those skilled in the art, there are many standard methods for distributing data across the logical storage unit 108. These methods are referred to as RAID levels.

For example, RAID level 0 improves I/O performance but does not provide redundancy. Thus, RAID level 0 may be used to store non-critical data and applications such as games. In RAID level 0 data is striped across the physical array of disk drives 108 by breaking data into blocks and writing each block to a separate drive. I/O performance is improved by spreading the load across many dives. However, RAID level 0 does not provide redundancy, that is, if one disk fails all data is lost.

RAID level 5 provides a high level of redundancy by striping both data and parity information across at least three disk drives. Data striping is combined with distributed parity to provide a recovery path in case of failure. Thus, RAID level 5 may be used to store critical data.

The array of disk drives 108 that form the single storage unit may be configured for the same RAID level or through a Matrix RAID capability, the single storage unit may be partitioned into a plurality of logical RAID volumes. Each RAID volume may be configured for a different RAID level. Critical files can be stored on one volume using one RAID level and non-critical files can be stored on another volume using another RAID level. For example, a user can edit digital video on a high performance 4-drive RAID 0 volume, and then transfer it to a RAID 5 volume for protected storage after completing the editing. In one embodiment, the disk drives are configured as a single storage unit with two RAID volumes, a first logical volume 120 configured for RAID level 0 and a second RAID volume configured for level 5.

In an embodiment of the invention, one of the RAID volumes is used to store a restore environment that is used to restore a backup image of the operating system. Each RAID volume has an associated “visibility” attribute that indicates whether the RAID volume is to be made visible to the operating system. Through the use of the “visibility” attribute, the RAID volume storing the restore environment is “hidden” from the operating system during normal operation.

An embodiment of the invention will be described for the Microsoft Windows operating system. However, the invention is not limited to the Microsoft Windows operating system and can be used in any computer system for recovery of any operating system. The RAID volumes are created prior to booting an operating system by firmware that may be stored in an option Read Only Memory (ROM) in the computer system 114. The RAID option ROM includes firmware that enables RAID creation and naming and deletion of RAID arrays to set up the RAID subsystem prior to booting an operating system. The option ROM also includes firmware that provides boot functionality for booting the operating system. As the RAID volumes are created prior to booting the operating system, they may be hidden from the operating system.

The system may also include a display 130 coupled to the ICH for displaying user interfaces for configuration utilities used for configuring the RAID subsystem and for user interfaces associated with recovery operations. The display 130 may comprise a cathode ray tube display, a solid state display such as a liquid crystal display, a plasma display, or a light-emitting diode display, among others.

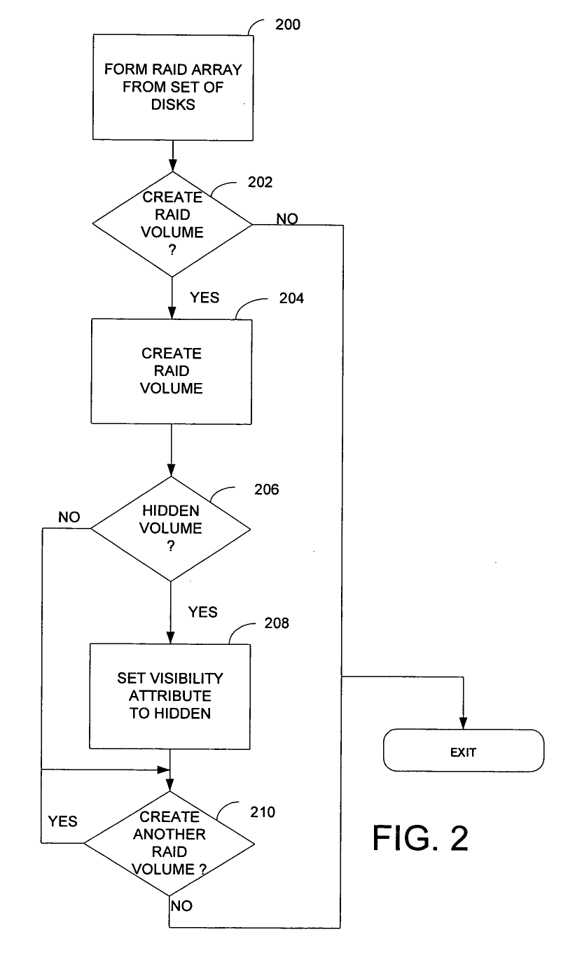

FIG. 2 is a flow chart illustrating a method implemented by the volume manager for creating a RAID volume. A RAID volume for creating a backup image may be created when the RAID system is initialized or configured based on configuration information received through a user interface. In an embodiment, the blocks in the flowchart may be implemented in a configuration utility program included in the firmware in the option ROM that is integrated into the system BIOS. For example, the configuration utility program may include a user interface that prompts a user to create a RAID volume, and to select a RAID level for the volume, the size of the volume, a strip size and the number of physical disk drives in the volume. In an alternate embodiment, the blocks in the flowchart may be implemented in an application program.

At block 200, a RAID array (single logical storage unit) is formed from the set of physical disk drives. For example, if there are four SATA disk drives 108A-D as shown in the embodiment in FIG. 1, a combined space is created that includes available space on all of the SATA disk drives 108A-C. Prior to forming the combined space, a portion of each disk drive is reserved for metadata, that is, data about the data stored in the RAID array. The metadata is used for managing the combined space. For example, the metadata stored for a RAID volume may include attributes indicating the size of a particular RAID volume and whether the RAID volume is to be hidden from the operating system. After the RAID array has been formed, processing continues with block 202.

At block 202, the RAID array may be logically partitioned into a plurality of RAID volumes, and each RAID volume may be configured for a different RAID level. If the array is to be partitioned to create a RAID volume, processing continues with block 204. If not, processing is complete.

At block 204, a RAID volume is created and information about the created RAID volume is stored in the metadata. The information includes a “visibility” attribute which is set to the “default” state of “exposed” to allow the volume to be visible to an operating system/BIOS. Processing continues with block 206.

At block 206, if the RAID volume is to be hidden, processing continues with block 208. If not, processing continues with block 210, to determine if there are other RAID volumes to be created in the combined logical space.

At block 208, the visibility attribute associated with the created volume stored in metadata is set to “hidden”. Processing continues with block 210.

At block 210, if there are other RAID volumes to be created in the array, processing continues with block 204. If not, all RAID volumes have been created and processing is complete.

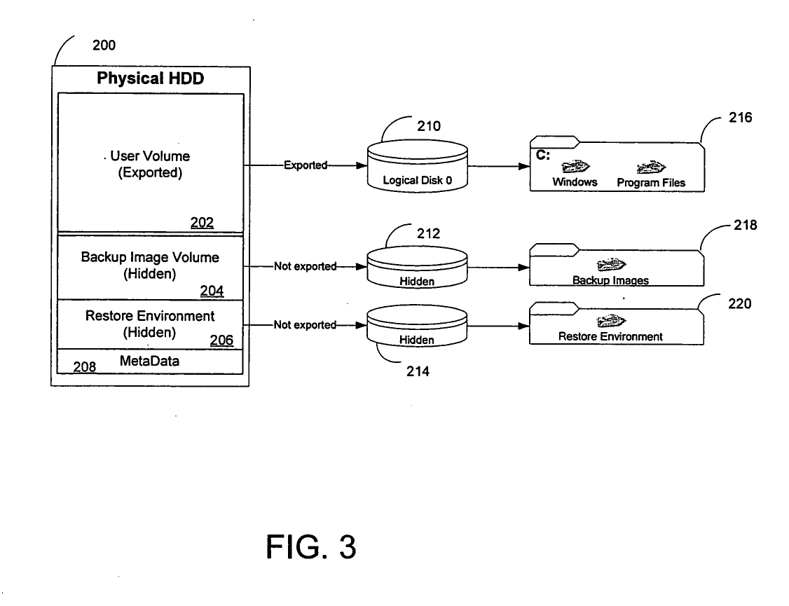

FIG. 3 illustrates a logical view of the set of physical disk drives during run-time. As shown, the physical array of disk drives 200 are partitioned into a metadata partition 208 and three RAID volumes 202, 204, 206 that span across the set of physical disk drives. One of the RAID volumes is a user volume 202 that is exported as “logical disk 0” 210. The user volume is exported to the operating system/BIOS in response to a query from the operating system/BIOS for a list of available volumes. The volume manager. “exports” a volume by incrementing a volume count and returning information about the volume.

“Logical disk 0” is visible to the operating system as “logical drive C:” as shown in user interface 216. The sub-folders “windows” and “program files” that are stored in the user volume 202 are also visible in “logical drive C:”.

The restore environment volume 206 stores a restore environment. The restore environment includes an operating system that is optimized for backup/restore operations and a backup/restore application. The restore environment may also be used to restore user data from backup images that may be stored in backup image volume 204 that is also hidden from the operating system during normal operation. A backup image is typically comprised of all the files on a volume in a hierarchical file system. In the embodiment shown there is a separate backup image volume 204. In an alternate embodiment, the backup image may be stored in a separate directory in the user volume 202.

A backup image volume 204 and restore environment volume 206 both have attribute “visibility” set to “hidden” and are thus not exported. Thus, there is no logical drive associated with each of these RAID volumes and thus the backup image volume and restore environment are not visible to the operating system/BIOS. The subfolder “backup images” 218 that is stored in the backup image volume 204 is not accessible by the BIOS or operating system. Similarly, the subfolder “restore environment” that is stored in the restore environment” volume 206 is not visible or accessible by the BIOS or operating system.

Only the exported user volume 202 is visible and accessible to the operating system, BIOS and users of the system as being stored on “logical volume 0” which is accessible by the operating system as “logical drive C:”. As all accesses to RAID volumes 202, 204 and 206 is through the volume manager, the files stored on the hidden RAID volumes are not visible to malicious software.

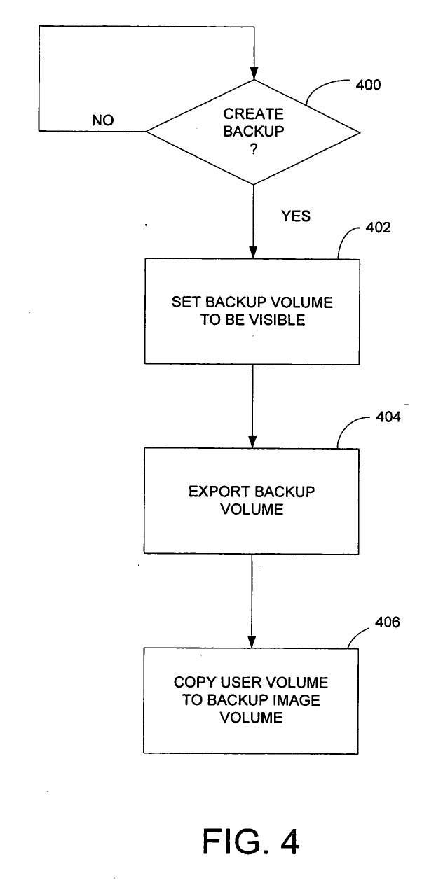

FIG. 4 is a flowchart of a method for creating a backup image according to an embodiment of the invention.

At block 400, if a backup image is to be created, processing continues with block 214. If not, wait for a request to create a backup image.

At block 402, the backup image volume “visibility” attribute stored in metadata 208 is modified to “exposed” to expose the backup image volume 204 to the operating system and the BIOS. The backup image volume 204 is now visible to the operating system and the BIOS. In one embodiment for the Microsoft Windows operating system, backup image volume is exported as “logical drive D:” and user volume 202 is exported as “logical drive C:”. Processing continues with block 404.

At block 404, the backup image volume 204 is exported as “logical disk 1” 212. The user volume 202 is exported as “logical disk 0” 210. Processing continues with block 406.

At block 406, with both backup image volume 204 and user volume 202 visible to the operating system and BIOS, a copy of the contents of user volume 202 may be stored in the backup image volume 204.

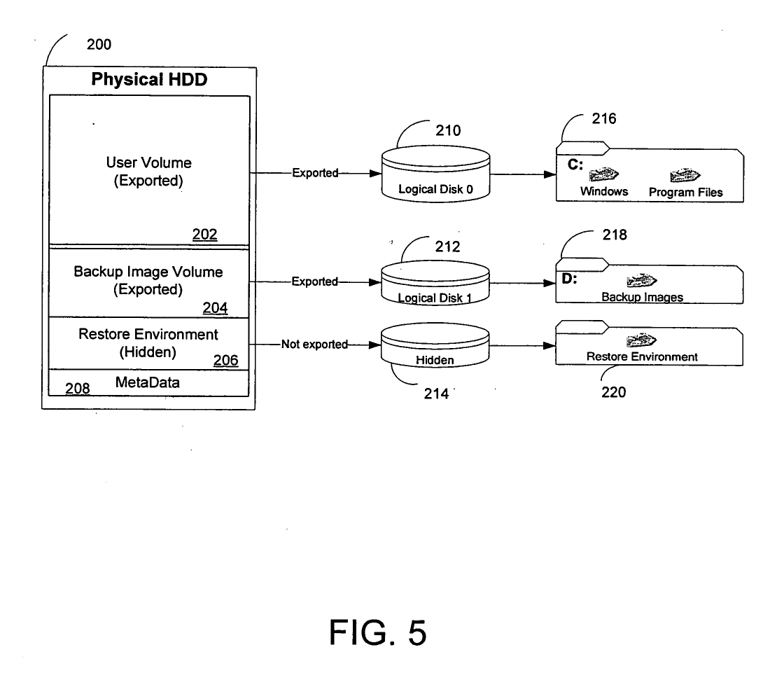

FIG. 5 is a logical view of an embodiment of the invention while a backup image is being taken of the user volume. As shown in FIG. 5, the physical set of disk drives 200 is partitioned into three RAID volumes 202, 204, 206 and a metadata partition 208. The restore environment volume 206 is written during install/initialization of the backup/restore software.

In order to allow the contents of the user volume 202 to be copied to the backup image volume 204, both RAID volumes must be visible to the operating system/BIOS. In order to be visible to the operating system/BIOS, the “visibility” attribute stored in the metadata partition 208 for both the user volume 202 and the backup image volume 204 must be set to “exposed”. The “visibility” attribute stored in the metadata partition 208 that is associated with the backup image volume 204 is modified to “exposed”, allowing the backup image volume 204 to be exported. The “visibility” attribute associated with the user volume 202 is already set to “exposed” as this volume is visible during runtime.

While the image is being taken of the user volume 202, in an embodiment using the Microsoft windows operating system, the backup image volume 204 is visible to the operating system, the BIOS and users of the system as “logical drive D:”, allowing the operating system to copy the contents of the user volume 202 to the backup image volume 204. However, the restore operating system environment 206 remains hidden from the operating system, the BIOS, and users of the system.

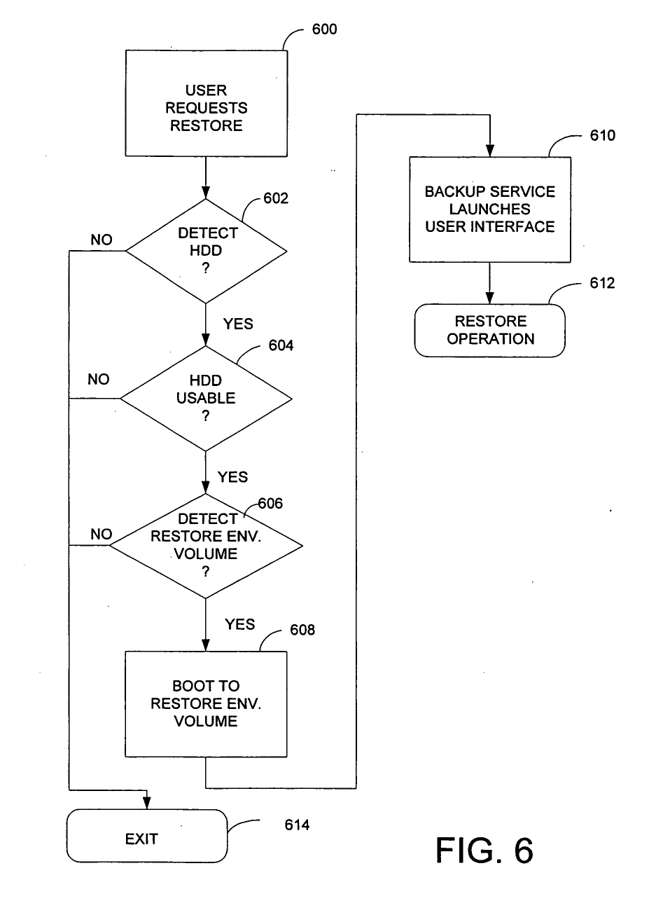

FIG. 6 is a flowchart of an embodiment of a method for restoring a user volume implemented in the Microsoft Windows operating system.

At block 600, a user requests a volume restore. For example, if the computer system is unable to boot the operating system stored in the user volume and the user of the computer system may request a restore operation through a hot-key combination during BIOS Power On Self Test (POST). The request for a volume restore is directed to firmware stored in option ROM associated with the RAID subsystem.

In another embodiment, a “failed boot counter” may be stored in non-volatile memory. This counter allows the volume manager to monitor the number of unsuccessful times that a user has tried to boot the operating system. When the operating system is successfully booted, the failed boot counter is decremented. Thus, the value of the failed boot counter represents a number of attempts to restore the operating system.

The failed boot counter provides the ability to automatically start the restore operation without requiring input from the user of the computer system. If the user tries repeatedly, but fails to boot the operating system, the failed boot counter will pass a predetermined threshold. When the failed boot counter passes this threshold, the firmware in the Option ROM will immediately start the restore operation without requiring user input. Thus, the failed boot counter removes the need for the user to request a restore operation to make the restore operation easier to use by less computer savvy users. Processing continues with block 602.

At block 602, the volume manager determines if it can detect hard disk drives storing the RAID volumes. If so, processing continues with block 604. If not, processing continues with block 614 to exit because the restore operation cannot be performed using the restore environment volume 206.

At block 604, the volume manager performs tests (diagnostics) on the detected disk drives to determine if the disk drives are usable. If so, processing continues with block 606. If not, processing continues with block 614 to exit because the restore operation cannot be performed. If the disk drives are not usable, an error message may be displayed on the user interface indicating that the disk drive is not usable and the volume manager may prompt the user to enter a valid disk drive from which the recover operation may be performed. For example, if the recover environment volume 206 is inaccessible due to a hardware problem with the disk drive, the restore operation may be directed to a restore environment volume stored on a removable media such as a CD or DVD.

At block 606, the volume manager reads the metadata 208 to determine if a restore environment volume 206 exists and whether the restore environment volume 206 is usable. If the restore environment volume 206 exits and is usable, processing continues with block 608. If not, processing continues with block 614 to exit because the restore operation cannot be performed. An error message may be displayed on the user interface.

At block 608, the volume manager exports the hidden backup image volume 204 and the restore environment volume 206, and hides the user volume 202. The user volume 202 is hidden by modifying the “visibility” attribute in the metadata 208 associated with the user volume 202 and the backup image volume 204 is exposed by modifying the “visibility” attribute associated with the backup image volume 204. The restore environment volume is exposed by modifying the “visibility” attribute associated with it. After the restore environment is exposed, the BIOS and operating system automatically boot from the restore environment 204, with no request required from the user. Processing continues with block 610.

At block 610, after the restore environment volume 206 boots the operating system, a user interface application is launched by the operating system to interact with the user for restore operations. Processing continues with block 612.

At block 612, the restore operation is performed. At the end of the restore operation, the failed boot counter is reset indicating that the restore operation was successful.

After the restore environment has booted, the volume storing the backup image may be exported and the backup image restored to the user volume, that is, the backup image volume is copied to the user volume to replace the user volume that may have been damaged or destroyed.

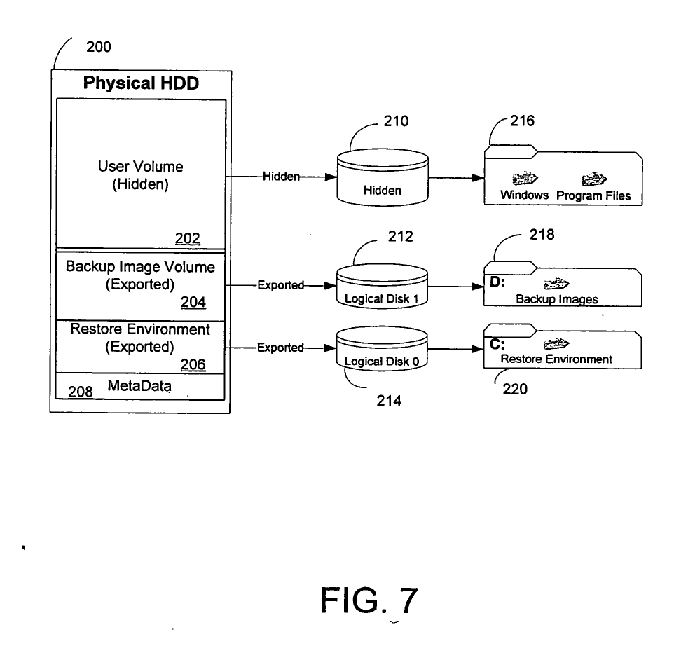

FIG. 7 is a logical view of an embodiment of the invention during restore. During restore, the user volume 202 is hidden through the “visibility” attribute associated with the user volume 202 that is stored in the metadata 208. The backup image volume 204 and the restore environment volume 206 are exported. This results in the BIOS and operating system booting from the restore environment volume 206 instead of from the user volume. This occurs without any interaction from the user, that is, in an embodiment for the Microsoft windows operating system, the backup image volume is exported to “logical drive D:” and the restore environment volume is exported to “logical drive C:”. In a system, that is set up to automatically boot from “logical drive C:”, the boot operation starts from the restore environment volume 206 which loads the backup image volume from “logical drive D:”. Thus, the restore operation occurs without requiring any decision making from the end user. The end user only ever sees one user volume when the operating system is booted. The restore environment is hidden during normal operation. Furthermore, there is no need to install a removable recovery disk. The backup image is not visible to the system and can only be accessed through the volume manager that is aware of the volumes that have been created in the RAID array.

It will be apparent to those of ordinary skill in the art that methods involved in embodiments of the present invention may be embodied in a computer program product that includes a computer usable medium. For example, such a computer usable medium may consist of a read only memory device, such as a CD ROM disk or conventional ROM devices, or a computer diskette, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

What is claimed is:

1. An apparatus comprising:
a volume manager capable of managing visibility of logical volumes in a redundant array of independent disks (RAID) subsystem, a first logical volume capable of storing an image, a second logical volume capable of storing a restore environment, the second volume being hidden from the operating system during runtime, upon detecting a request for a restore operation, the second logical volume being dynamically exposed to the operating system and the first logical volume being hidden from the operating system.

2. The apparatus of claim 1, further comprising:
a third logical volume capable of storing a backup image user data, the third logical volume being dynamically exposed to the operating system during a restore operation.

3. The apparatus of claim 1, wherein the first logical volume and the second logical volume are redundant array of independent disk logical volumes.

4. The apparatus of claim 1, wherein each logical volume has an associated visibility attribute stored as metadata in the RAID subsystem.

5. The apparatus of claim 4, wherein the second logical volume is dynamically exposed by modifying the visibility attribute associated with the second logical volume.

6. A method comprising:
storing an image on a first logical volume of a redundant array of independent disks (RAID) subsystem, the first logical volume being visible to an operating system;
storing a restore environment on a second logical volume of the RAID subsystem, the second logical volume being hidden from the operating system; and
upon detecting a request for a restore operation, the second logical volume being dynamically exposed to the operating system and the first logical volume being hidden from the operating system.

7. The method of claim 6, further comprising:
storing a backup image user data on a third logical volume the third logical volume being dynamically exposed to the operating system during a restore operation.

8. The method of claim 6, wherein the first logical volume and the second logical volume are redundant array of independent disk logical volumes.

9. The method of claim 6, wherein each logical volume has an associated visibility attribute stored as metadata in the RAID subsystem.

10. The method of claim 9, wherein the second logical volume is dynamically exposed by modifying the visibility attribute associated with the second logical volume.

11. A system comprising:
a volume manager capable of managing visibility of logical volumes in a redundant array of independent disks (RAID) subsystem, a first logical volume capable of storing an image, a second logical volume capable of storing a restore environment, the second volume being hidden from the operating system during runtime, upon detecting a request for a restore operation, the second logical volume being dynamically exposed to the operating system and the first logical volume being hidden from the operating system; and
a liquid crystal display coupled to the volume manager to display contents of visible logical volumes.

12. The system of claim 11, further comprising:
a third logical volume capable of storing a backup image user data, the third logical volume being dynamically exposed to the operating system during a restore operation.

13. The system of claim 11, wherein the first logical volume and the second logical volume are redundant array of independent disk logical volumes.

14. The system of claim 11, wherein each logical volume has an associated visibility attribute stored as metadata in the RAID subsystem.

15. The system of claim 14, wherein the second logical volume is dynamically exposed by modifying the visibility attribute associated with the second logical volume.

16. An article including a machine-accessible medium having associated information, wherein the information, when accessed, results in a machine performing:
storing an image on a first logical volume of a redundant array of independent disks (RAID) subsystem, the first logical volume being visible to an operating system;
storing a restore environment on a second logical volume of the RAID subsystem, the second logical volume being hidden from the operating system; and
upon detecting a request for a restore operation, the second logical volume being dynamically exposed to the operating system and the first logical volume being hidden from the operating system.

17. The article of claim 16, further comprising:
storing a backup image user data on a third logical volume the third logical volume being dynamically exposed to the operating system during a restore operation.

18. The article of claim 16, wherein the first logical volume and the second logical volume are redundant array of independent disk logical volumes.

19. The article of claim 16, wherein each logical volume has an associated visibility attribute stored as metadata in the RAID subsystem.

20. The article of claim 19, wherein the second logical volume is dynamically exposed by modifying the visibility attribute associated with the second logical volume.
